(19) United States
(12) Patent Application Publication
(10) Pub. No.: US 2011/0014558 A1
(43) Pub. Date: Jan. 20, 2011

(54) DEVELOPING AGENT AND METHOD FOR PRODUCING THE SAME

(75) Inventors: Masahiro Ikuta, Shizuoka-ken (JP); Takayasu Aoki, Shizuoka-ken (JP); Takashi Urabe, Shizuoka-ken (JP); Tsuyoshi Itou, Shizuoka-ken (JP); Motonari Udo, Shizuoka-ken (JP); Satoshi Araki, Shizuoka-ken (JP); Takafumi Hara, Shizuoka-ken (JP); Yasuhito Noda, Shizuoka-ken (JP); Taishi Takano, Shizuoka-ken (JP); Yasuo Goto, Shizuoka-ken (JP); Junichi Ishikawa, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/832,380

(22) Filed: Jul. 8, 2010

Related U.S. Application Data
(60) Provisional application No. 61/225,760, filed on Jul. 15, 2009.

(51) Int. Cl. G03G 9/08

(52) U.S. Cl. 430/108.1; 430/137.14

(57) ABSTRACT

According to one embodiment, a method for producing a developing agent including aggregating fine particles of a toner material containing a binder resin and a coloring agent in a dispersion liquid in which the fine particles are dispersed in an aqueous medium to form aggregated particles, and washing the aggregated particles and drying the washed aggregated particles, forming toner particles is provided. An electrical conductivity of the toner particles is measured by a toner electrical conductivity evaluation method. A sample toner is prepared by adhering an additive to surfaces of the toner particles, and a content ratio of a sodium element to a carbon element in a region to which the additive is not adhered of the toner is measured. The washing of the toner particles is repeated until each of the measurement values becomes a predetermined reference value or less.

### CROSS-REFERENCE TO RELATED APPLICATIONS

This application is based upon and claims the benefit of priority from U.S. Provisional Application No. 61/225,760, filed Jul. 15, 2009; the entire contents of which are incorporated herein by reference.

### FIELD

Embodiments described herein relate generally to a recording material such as a developing agent to be used in an electrophotographic process, an electrostatic printing process, a magnetic recording process, or the like, or an ink to be used in inkjet printing or the like; and a method for producing the same.

### BACKGROUND

In a conventional electrophotographic process, an electrical latent image is formed on an image carrying member, then, the latent image is developed with a toner, and the resulting toner image is transferred onto a transfer material such as paper and then fixed by heating, applying pressure, or the like. As the toner to be used, not only a conventional single black color toner, but also, in order to form a full color image, toners of a plurality of colors are used and an image is formed. As the toner, a two-component developing agent to be used by mixing with carrier particles and a one-component developing agent to be used as a magnetic toner or a non-magnetic toner are known. These toners are generally produced by a kneading pulverization method. This kneading pulverization method is a method for producing desired toner particles by melt-kneading a binder resin, a pigment, a release agent such as a wax, a charge control agent, and the like, cooling the resulting kneaded material, followed by pulverizing the cooled kneaded material, and then classifying the pulverized particles. Inorganic and/or organic fine particles are added to surfaces of toner particles produced by the kneading pulverization method in accordance with the intended use, and thus, a toner can be obtained.

When toner particles are produced by the kneading pulverization method, their shape is amorphous and their surface composition is not uniform in general. Although the shape and surface composition of toner particles are subtly changed depending on the pulverizability of the material to be used and conditions for the pulverization process, it is difficult to intentionally control the shape.

Further, when a material with a particularly high pulverizability is used, the particles are further finely pulverized or their shape is changed due to various stresses in a developing machine. As a result, in a two-component developing agent, a problem sometimes arises that the finely pulverized toner is adhered to the surface of a carrier to accelerate the deterioration of chargeability of the developing agent. Also, in a one-component developing agent, a problem sometimes arises that the particle size distribution is increased, the finely pulverized toner is scattered, or developability is deteriorated due to a change in the toner shape, and therefore, an image quality is deteriorated.

Further, when the toner contains a release agent such as a wax, the release agent may sometimes be exposed on a toner surface because pulverization is easily caused at an interface between the binder resin and the release agent. In particular, when the toner is formed from a resin which has a high elasticity and is hardly pulverized and a brittle wax such as polyethylene, exposure of polyethylene on a toner surface is much seen. Although such a toner is advantageous in terms of a release property at fixing and also in terms of cleaning of untransferred toner on a photoconductor, the polyethylene on a toner surface is detached from the toner by a mechanical force such as a shearing force in the developing machine and can be easily transferred onto a developing roll, an image carrying member, a carrier, or the like. Therefore, contamination of the developing roll, image carrying member, carrier, or the like with the wax is likely to be caused, and the reliability as a developing agent is sometimes lowered.

Under such circumstances, recently, as a method for producing a toner in which the shape and surface composition of toner particles are intentionally controlled, an emulsion polymerization aggregation method is proposed.

The emulsion polymerization aggregation method is a method of obtaining toner particles by separately preparing a resin dispersion liquid by emulsion polymerization and a coloring agent dispersion liquid in which a coloring agent is dispersed in a solvent, mixing these dispersion liquids to form aggregated particles with a size corresponding to a toner particle size, and fusing the aggregated particles by heating. According to this emulsion polymerization aggregation method, the toner shape can be arbitrarily controlled from amorphous to spherical shape by selecting a heating temperature condition.

In the emulsion polymerization aggregation method, a toner can be obtained by subjecting at least a dispersion liquid of resin fine particles and a dispersion liquid of a coloring agent to aggregation and fusion under a given condition. However, the emulsion polymerization aggregation method is limited as to the type of resin which can be synthesized, and a polyester resin which is known to have a good fixability cannot be used in the method, though the method is suitable for the production of a styrene-acrylic copolymer. Further, when the fine particles are aggregated, a water-soluble metal salt, particularly a water-soluble high-valent metal salt is adopted from the viewpoint that a desired particle size distribution can be obtained. On the other hand, as a method for producing a toner using a polyester resin, a phase inversion emulsification method in which a pigment dispersion liquid or the like is added to a solution obtained by dissolving a polyester resin in an organic solvent and then water is added thereto is known. However, it is necessary to remove and recover the organic solvent. A method for producing fine particles by mechanical shearing in an aqueous medium without using an organic solvent is proposed. However, it is necessary to feed a resin or the like in a molten state to a stirring device, and handling thereof is difficult. Further, the degree of freedom for shape control is low, and the shape of a toner cannot be arbitrarily controlled from amorphous to spherical shape.

In view of the above circumstances, a production method capable of freely designing a particle size distribution and a toner shape using a polyester resin is developed.

For a toner produced by a wet process, regardless of the production method, a step of washing and removing unnecessary substances such as a surfactant and an aggregating agent other than the toner is needed. The determination as to whether or not impurities can be sufficiently washed and removed is generally performed on the basis of the electrical conductivity of a washing waste liquid when a toner slurry is washed or the electrical conductivity of water obtained when a toner is dispersed in water. Further, as a method of analyzing the amount of a residual additive, an analysis of a toner after washing and drying by wavelength dispersive X-ray fluorescence analysis or X-ray photoelectron spectroscopy analysis is known.

However, a toner obtained by the production method including a step of preparing fine particles by emulsifying a polyester resin in an aqueous medium has a problem that the charging property is deteriorated due to the effect of a surfactant or an aggregating agent added for improving the self-dispersibility in the aqueous medium.

Further, the wavelength dispersive X-ray fluorescence analysis can analyze elements contained in the toner particles, but cannot analyze a surfactant and an aggregating agent which are present on a toner surface and considered to particularly affect the charging property. The X-ray photoelectron spectroscopy analysis can analyze a toner surface, but cannot analyze a specific region of a toner surface.

### BRIEF DESCRIPTION OF THE DRAWINGS

FIG. 1 is a flow diagram showing one example of a method for producing a developing agent according to an embodiment.

FIG. 2 is a view showing a structure of one example of a mechanical shearing device to be used in an embodiment.

### DETAILED DESCRIPTION

In general, a method for producing a developing agent according to one embodiment includes forming toner particles by aggregating fine particles of a toner material containing a binder resin and a coloring agent in a dispersion liquid in which the fine particles are dispersed in an aqueous medium to form aggregated particles, and washing the aggregated particles, and then drying the washed aggregated particles. In the method, by using sample toner particles prepared by sampling a portion of the toner obtained by washing and drying the aggregated particles, and a sample toner prepared by adhering (externally adding) an additive to surfaces of the sample toner particles, measurement with respect to a residual surfactant is performed, and the washing of the toner after drying is repeated depending on the measurement results for the sample toner particles and sample toner.

First, as one measurement with respect to the surfactant, the toner particles are washed with washing water, and the electrical conductivity of the washing water after washing is measured. When the electrical conductivity exceeds 50 μS/cm, the aggregated particles are rewashed until the electrical conductivity becomes 50 μS/cm or less. After the electrical conductivity becomes 50 μS/cm or less, the toner particles are dried, and a portion of the toner particles are sampled and the electrical conductivity thereof is measured by a toner electrical conductivity evaluation method. If the electrical conductivity is 50 μS/cm or less, an additive is adhered to surfaces of the sample toner particles, thereby preparing a sample toner. If the electrical conductivity is more than 50 μS/cm, the toner is washed and dried again, and a portion thereof is sampled, and the electrical conductivity thereof is measured by the toner electrical conductivity evaluation method. This procedure is repeated until the electrical conductivity is 50 μS/cm or less, and the external addition is performed.

Thereafter, as the other measurement with respect to the surfactant, a composition of a region to which the additive is not adhered of a surface of the sample toner is analyzed using an energy dispersive X-ray analyzer (EDX). When the content ratio of a sodium element to carbon in the region to which the additive is not adhered exceeds 5 atom %, the toner is rewashed until the content ratio becomes 5 atom % or less. The washing and drying are repeated until the content ratio becomes 5 atom % or less, whereby the toner is obtained.

Further, a developing agent according to one embodiment is a developing agent obtained by the above-mentioned method for producing a developing agent, and contains toner particles obtained by aggregating fine particles of a toner material containing a binder resin and a coloring agent in a dispersion liquid in which the fine particles are dispersed in an aqueous medium to form aggregated particles, and washing the aggregated particles, and then drying the washed aggregated particles, and an additive adhered to surfaces of the toner particles.

Here, the aggregated particles are washed until the electrical conductivity of washing water after washing becomes 50 μS/cm or less, and subsequently, a composition of a region to which the additive is not adhered of a toner surface is analyzed using an energy dispersive X-ray analyzer (EDX) and the content ratio of a sodium element to carbon is determined, and the aggregated particles are washed until the content ratio becomes 5 atom % or less.

In the method for producing a developing agent according to one embodiment, the electrical conductivity of the washing water in the washing step is 50 μS/cm or less, and a region to which the additive is not adhered of the toner after performing external addition is confirmed using a scanning electron microscope (SEM), and an elemental analysis of particles is performed at low energy using an energy dispersive X-ray fluorescence analyzer (EDX) attached to the scanning electron microscope (SEM). According to this method, it becomes possible to reduce the residue of a surfactant to be used in the production step of a developing agent without measuring elements in the inside of the toner particles. Further, by setting the ratio of a sodium element derived from the surfactant remaining on the surfaces of the toner particles which particularly affects the charging property to a carbon element in the toner (Na/C) to 5 atom % or less, the charging property can be improved.

Hereinafter, embodiments will be described in more detail with reference to the drawings.

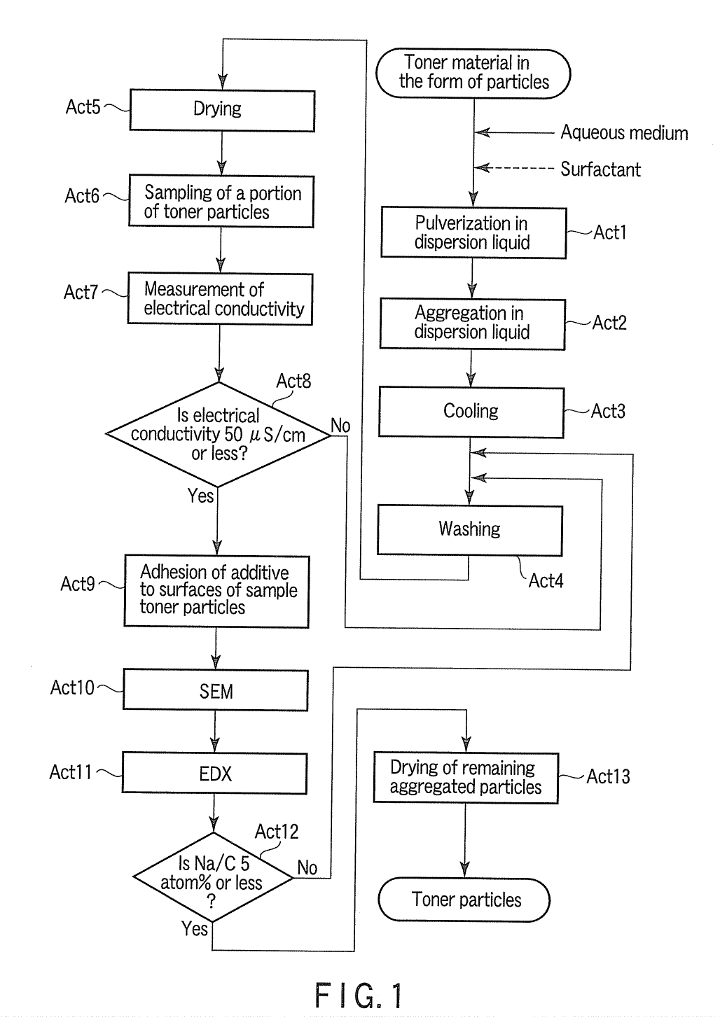

FIG. 1 is a flow diagram showing one example of a method for producing a developing agent according to an embodiment.

A toner material in the form of particles containing, for example, a binder resin and a coloring agent is prepared. The toner material in the form of particles can be prepared by melt-kneading a mixture of a toner material containing, for example, a binder resin and a coloring agent, and crushing the kneaded material into coarse particles.

To this toner material in the form of particles, for example, an aqueous medium, a surfactant, and the like are added, and a dispersion liquid of the toner material in the form of particles is prepared. Subsequently, the dispersion liquid of the toner material is pulverized by, for example, applying a mechanical shearing force (Act 1).

In this manner, a dispersion liquid in which fine particles of a toner material containing a binder resin and a coloring agent are dispersed in an aqueous medium is obtained.

Subsequently, the fine particles are aggregated in the dispersion liquid, thereby forming aggregated particles (Act 2).

After cooling the formed aggregated particles (Act 3), the aggregated particles are washed such that the electrical conductivity of the washing water becomes 50 μS/cm or less (Act 4).

Thereafter, the washed aggregated particles are dried, thereby forming toner particles (Act 5).

Then, a portion of the dried toner is sampled (Act 6).

The electrical conductivity of the sampled toner is measured by an electrical conductivity evaluation method (Act 7).

It is determined whether or not the electrical conductivity is 50 μS/cm or less (Act 8).

When the electrical conductivity exceeds 50 μS/cm, the toner after drying is further rewashed (Act 4).

The washing of the toner after drying is repeated until the electrical conductivity of the sample toner particles evaluated by the electrical conductivity evaluation method is 50 μS/cm or less (Act 5, Act 6, Act 7, Act 8).

After the electrical conductivity becomes 50 μS/cm or less, an additive is adhered to surfaces of the sample toner particles (external addition) (Act 9).

A region to which the additive is not adhered is confirmed using SEM (Act 10), and a composition of the region to which the additive is not adhered is analyzed using an energy dispersive X-ray analyzer (EDX) (Act 11).

When the content ratio of a sodium element to carbon exceeds 5 atom % in the composition of the region to which the additive is not adhered, the toner after drying is further washed (Act 4).

The washing of the toner after drying is repeated until the content ratio of a sodium element to carbon in the composition of the region to which the additive is not adhered becomes 5 atom % or less (Act 5, Act 6, Act 9, Act 10, Act 11, Act 12).

After the content ratio of a sodium element to carbon becomes 5 atom % or less, the remaining toner after drying is subjected to external addition (Act 13), thereby forming toner particles.

The washing performance of the toner can be evaluated on the basis of the electrical conductivity of the washing water and the elemental analysis of the toner surface.

### Toner Electrical Conductivity Evaluation Method

In a method of evaluating the electrical conductivity of washing water, after washing and drying a toner, water having an electrical conductivity of 0 μS/cm is added to the toner in an amount of 10 g per g of the toner, and the resulting liquid is treated with an ultrasonic washer for 10 minutes, and the treated liquid is filtered, and the electrical conductivity of the filtrate is set to 50 μS/cm or less. The electrical conductivity of the filtrate can be set to 30 μS/cm or less, and further can be set to 20 μS/cm or less.

When the electrical conductivity of the washing water after washing and drying is more than 50 μS/cm, the washing and drying steps can be repeated until the electrical conductivity of the washing water after washing and drying becomes 50 μS/cm or less.

The electrical conductivity of the washing water after the washing step is 50 μS/cm or less, and a region to which the additive is not adhered of the toner after performing external addition is confirmed by a scanning electron microscope (SEM), and an elemental analysis of particles is performed at low energy by an energy dispersive X-ray fluorescence analyzer (EDX) attached to the scanning electron microscope (SEM). According to this method, the ratio of a sodium element derived from a surfactant which is present on the surfaces of the toner particles and particularly affects the charging property to a carbon element in the toner (Na/C) can be set to 5 atom % or less without measuring elements in the inside of the toner particles.

Hereinafter, an embodiment will be described.

In an embodiment, in the case of a toner produced by a wet process using an emulsion aggregation method, in the production process thereof, it is necessary to add a surfactant for dispersing fine particles in the pulverizing step, and also to add an aggregating agent and a stabilizing agent in the aggregating and fusing step. Many of these additives deteriorate the charging property of the toner, and particularly, it may be not suitable that such substances remain on a toner surface. Therefore, by sufficiently washing the toner in the washing step or reducing the addition amount of such substances so as to reduce the residual amount thereof, the charging property is improved. Among the additives, a surfactant has high hygroscopicity due to the molecular structure thereof, and in general, it is sometimes used as an antistatic agent. Therefore, it is considered that when a surfactant is present on a toner surface, the resistance is decreased, and thus, deterioration of the charging property is caused. In particular, image deterioration is more likely to occur under high humidity.

The washing performance of the toner can be evaluated on the basis of an electrical conductivity of washing water and an elemental analysis of a toner surface. As the evaluation method on the basis of an electrical conductivity of washing water, the above-mentioned toner electrical conductivity evaluation method can be employed.

If the electrical conductivity is more than 50 μS/cm, additives which were not washed away are present much in the toner, and a sufficient charging property cannot be obtained.

As for the evaluation method by an elemental analysis, in a region to which an additive is adhered, a toner surface is not exposed, and therefore, an effect of an additive on the charging property is very small. On the other hand, in a region to which an additive is not adhered, an additive is exposed on a toner surface, and therefore, the additive adversely affects the charging property. When an elemental analysis of the region to which an additive is not adhered is performed using EDX attached to SEM and the intensity ratio of a sodium element to a carbon element contained in the toner surface is 5 atom % or less, deterioration of the charging property can be suppressed, and therefore, deterioration of an image quality such as fogging can be prevented.

When the intensity ratio of a sodium element to a carbon element contained in the toner surface measured using EDX attached to SEM is more than 5 atom %, the charging property is deteriorated by a surfactant present on the toner surface, and deterioration of an image such as fogging is caused.

The observation and elemental analysis of the toner surface in Examples were performed using EDX (QX-400, manufactured by Bruker Co., Ltd.) attached to SEM (Ultra 55, manufactured by Carl Zeiss).

### Measurement Conditions

Accelerating voltage: 7.5 kV, Aperture diameter: 120 μl (high current mode), WD: 8 mm

As the shape of the toner approaches a sphere (the circularity thereof approaches 1), an additive is uniformly adhered to the toner, and therefore, it becomes possible to prevent exposure of a region to which the additive is not adhered and which adversely affect the charging property. However, when the shape of the toner is a sphere, the cleaning performance is deteriorated. Therefore, the circularity of the toner can be in a range from 0.92 to 0.98. However, it is known that when the circularity thereof is in a range from 0.92 to 0.98, the toner surface has an irregularity and the additive is unevenly adhered to the toner surface so as to generate a region to which the additive is not adhered, and therefore, the charging property is deteriorated. In order to improve the charging property, it is necessary to fulfill the requirements that the electrical conductivity of washing water is 50 μS/cm or less and that when a region to which the additive is not adhered is measured using EDX, the intensity ratio of a sodium element to a carbon element contained in the toner surface is 5 atom % or less.

As the materials to be used in the embodiment, any of known materials such as a resin, a coloring agent, a release agent, a charge control agent, an aggregating agent, and a neutralizing agent can be used.

A binder resin to be used in the embodiment is not particularly limited as long as it is a resin having a dissociable group, however, in consideration of the fixing property or the like, it is desirable to use a polyester resin. As the resin, one kind of resin may be used alone or two or more kinds of resins may be used in combination.

The binder resin may have an acid value of 1 mg/mgKOH or more.

Examples of the coloring agent to be used in the embodiment include carbon blacks, and organic or inorganic pigments or dyes. Examples of the carbon black include acetylene black, furnace black, thermal black, channel black, and Ketjen black. Further, examples of a yellow pigment include C.I. Pigment Yellow 1, 2, 3, 4, 5, 6, 7, 10, 11, 12, 13, 14, 15, 16, 17, 23, 65, 73, 74, 81, 83, 93, 95, 97, 98, 109, 117, 120, 137, 138, 139, 147, 151, 154, 167, 173, 180, 181, 183, and 185, and C.I. Vat Yellow 1, 3, and 20. These can be used alone or in admixture. Further, examples of a magenta pigment include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 146, 150, 163, 184, 185, 202, 206, 207, 209, and 238, C.I. Pigment Violet 19, and C.I. Vat Red 1, 2, 10, 13, 15, 23, 29, and 35. These can be used alone or in admixture. Further, examples of a cyan pigment include C.I. Pigment Blue 2, 3, 15, 16, and 17, C.I. Vat Blue 6, and C.I. Acid Blue 45. These can be used alone or in admixture. To the mixture formed into coarse particles, at least one of a wax and a charge control agent can be further added.

Examples of the release agent to be used in the embodiment include aliphatic hydrocarbon waxes such as low-molecular weight polyethylene, low-molecular weight polypropylene, polyolefin copolymers, polyolefin waxes, microcrystalline waxes, paraffin waxes, and Fischer-Tropsch waxes; oxides of an aliphatic hydrocarbon wax such as polyethylene oxide waxes or block copolymers thereof; vegetable waxes such as candelilla wax, carnauba wax, Japan wax, jojoba wax, and rice wax; animal waxes such as bees wax, lanolin, and whale wax; mineral waxes such as ozokerite, ceresin, and petrolatum; waxes containing, as a main component, a fatty acid ester such as montanic acid ester wax and castor wax; and deoxidation products resulting from deoxidation of a part or the whole of a fatty acid ester such as deoxidized carnauba wax. Further, saturated linear fatty acids such as palmitic acid, stearic acid, montanic acid, and long-chain alkyl carboxylic acids having a longer chain alkyl group; unsaturated fatty acids such as brassidic acid, eleostearic acid, and parinaric acid; saturated alcohols such as stearyl alcohol, eicosyl alcohol, behenyl alcohol, carnaubyl alcohol, ceryl alcohol, melissyl alcohol, and long-chain alkyl alcohols having a longer chain alkyl group; polyhydric alcohols such as sorbitol; fatty acid amides such as linoleic acid amide, oleic acid amide, and lauric acid amide; saturated fatty acid bisamides such as methylenebisstearic acid amide, ethylenebiscaprylic acid amide, ethylenebislauric acid amide, and hexamethylenebisstearic acid amide; unsaturated fatty acid amides such as ethylenebisoleic acid amide, hexamethylenebisoleic acid amide, N,N′-dioleyladipic acid amide, and N,N′-dioleylsebacic acid amide; aromatic bisamides such as m-xylenebisstearic acid amide, and N,N′-distearylisophthalic acid amide; fatty acid metal salts (generally called metallic soaps) such as calcium stearate, calcium laurate, zinc stearate, and magnesium stearate; waxes obtained by grafting of a vinyl monomer such as styrene or acrylic acid on an aliphatic hydrocarbon wax; partially esterified products of a fatty acid and a polyhydric alcohol such as behenic acid monoglyceride, and methyl ester compounds having a hydroxyl group obtained by hydrogenation of a vegetable fat or oil can be exemplified.

Further, as the charge control agent for controlling a frictional charge quantity, for example, a metal-containing azo compound is used, and a complex or a complex salt in which the metal element is iron, cobalt, or chromium, or a mixture thereof can be used. Other than these, a metal-containing salicylic acid derivative compound can also be used, and a complex or a complex salt in which the metal element is zirconium, zinc, chromium, or boron, or a mixture thereof can be used.

Examples of the surfactant which can be used in the embodiment include anionic surfactants such as sulfate-based, sulfonate-based, phosphate-based, and soap-based anionic surfactants; cationic surfactants such as amine salt-based and quaternary ammonium salt-based cationic surfactants; and nonionic surfactants such as polyethylene glycol-based, alkyl phenol ethylene oxide adduct-based, and polyhydric alcohol-based nonionic surfactants.

In the embodiment, when the fine particles are aggregated, a water-soluble metal salt can be used. Examples of the water-soluble metal salt include metal salts such as sodium chloride, calcium chloride, calcium nitrate, barium chloride, magnesium chloride, zinc chloride, magnesium sulfate, aluminum chloride, and aluminum sulfate; and inorganic metal salt polymers such as poly(aluminum chloride), poly(aluminum hydroxide), and calcium polysulfide.

In the embodiment, when the fine particles are aggregated, an organic solvent may be used. Examples of the organic solvent include alcohols such as methanol, ethanol, 1-propanol, 2-propanol, 2-methyl-2-propanol, 2-methoxyethanol, 2-ethoxyethanol, and 2-butoxyethanol, acetonitrile, and 1,4-dioxane.

In the embodiment, when the fine particles are aggregated, an acid may be used. As the acid, it can be used that, for example, any one or more of nitric acid, sulfuric acid, hydrochloric acid, acetic acid, acetic anhydride, phosphoric acid, and citric acid.

The pH adjusting agent which can be used in the embodiment is not particularly limited, however, for example, an amine compound can be used other than sodium hydroxide, potassium hydroxide, or the like. Examples of the amine compound include dimethylamine, trimethylamine, monoethylamine, diethylamine, triethylamine, propylamine, isopropylamine, dipropylamine, butylamine, isobutylamine, sec-butylamine, monoethanolamine, diethanolamine, triethanolamine, triisopropanolamine, isopropanolamine, dimethylethanolamine, diethylethanolamine, N-butyldiethanolamine, N,N-dimethyl-1,3-diaminopropane, and N,N-diethyl-1,3-diaminopropane. From the viewpoint of the ability to improve the self-dispersibility of a polyester resin, the pH adjusting agent can be particularly an organic amine compound.

Examples of the mechanical shearing device to be used in the embodiment include mechanical shearing devices which do not use a medium such as Ultra Turrax (manufactured by IKA Japan K.K.), T.K. Auto Homo Mixer (manufactured by PRIMIX Corporation), T.K. Pipeline Homo Mixer (manufactured by PRIMIX Corporation), T.K. Filmics (manufactured by PRIMIX Corporation), Clear Mix (manufactured by M TECHNIQUE Co., Ltd.), Clear SS5 (manufactured by M TECHNIQUE Co., Ltd.), Cavitron (manufactured by EUROTEC, Ltd.), Fine Flow Mill (manufactured by Pacific Machinery & Engineering Co., Ltd.), Microfluidizer (manufactured by Mizuho Industry Co., Ltd.), Starburst (manufactured by Sugino Machine Limited), Nanomizer (manufactured by Yoshida Kikai Co. Ltd.), Genus PY (manufactured by Hakusui Chemical Industries Co., Ltd.), and NANO 3000 (manufactured by Beryu Co., Ltd.); and mechanical shearing devices which use a medium such as Visco Mill (manufactured by Aimex Co., Ltd.), Apex Mill (manufactured by Kotobuki Industries Co., Ltd.), Star Mill (manufactured by Ashizawa Finetech Co., Ltd.), DCP Superflow (manufactured by Nippon Eirich Co., Ltd.), MP Mill (manufactured by Inoue Manufacturing Co., Ltd.), Spike Mill (manufactured by Inoue Manufacturing Co., Ltd.), Mighty Mill (manufactured by Inoue Manufacturing Co., Ltd.), and SC Mill (manufactured by Mitsui Mining Co., Ltd.).

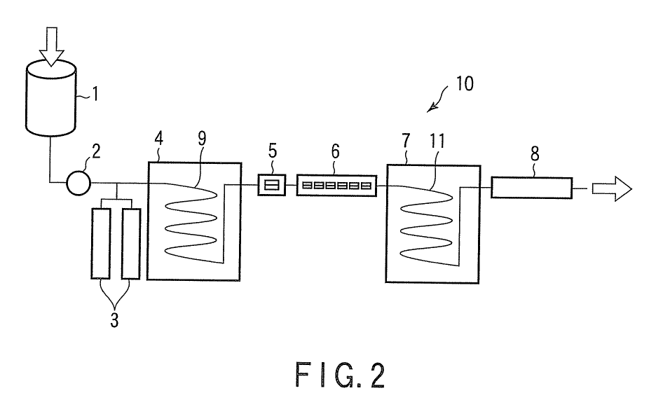

FIG. 2 is a view showing a structure of one example of a mechanical shearing device to be used in an embodiment.

As shown in FIG. 2, a high-pressure homogenizer 10 has a structure in which a hopper tank 1, a liquid feed pump 2, a high-pressure pump 3, a heating unit 4, a pulverizing unit 5, a pressure reducing unit 6, a cooling unit 7, and a pressure reducing unit 8 are arranged in this order, and includes pipes which connect the respective units.

The hopper tank 1 is a tank to which a process liquid is fed. While the device is being operated, it is necessary to always fill the tank with a liquid so as not to send air to the device. When the particles in the process liquid have a large particle diameter and are likely to precipitate, a stirrer can be further installed in the tank.

The liquid feed pump 2 is installed for continuously feeding the process liquid to the high-pressure pump 3. Further, this liquid feed pump 2 is also effective in avoiding clogging of a check valve (not shown) installed in the high-pressure pump 3. As the pump 2, for example, a diaphragm pump, a tubing pump, a gear pump, or the like can be used.

The high-pressure pump 3 is a plunger pump and has check valves at a process liquid inlet port (not shown) and a process liquid outlet port (not shown). The number of plungers varies depending on the production scale, and one to ten plungers are used. In order to reduce a pulsating current as much as possible, it can be used that two or more plungers.

The heating unit 4 is provided with a high-pressure pipe 9 formed in a spiral shape so as to have a large heat exchange area in a heating device such as an oil bath. It does not matter whether this heating unit 4 is installed on the upstream side or downstream side of the high-pressure pump 3 in the flow direction of the dispersion liquid, however, it is necessary to install this heating unit 4 at least on the upstream side of the pulverizing unit 5. When the heating unit 4 is installed on the upstream side of the high-pressure pump 3, a heating device may be installed in the hopper tank 1, however, the time for which the process liquid is retained at a high temperature is long, and therefore, thermal decomposition of the binder resin is liable to occur.

The pulverizing unit 5 includes a nozzle having a small diameter for applying a strong shearing force. The diameter and shape of the nozzle vary, however, the diameter thereof can be from 0.05 mm to 0.5 mm, and as for the shape thereof, a pass-through type nozzle or an impingement type nozzle can be used. Further, this nozzle may be configured in a multiple stage structure. When a multiple stage structure is employed, a plurality of nozzles having different diameters may be arranged. As for the configuration of the arrangement of a plurality of nozzles, either parallel or series configuration may be employed. As the material of the nozzle, diamond or the like which can withstand a high pressure is used.

The cooling unit 7 is provided with a pipe 11 formed in a spiral shape so as to have a large heat exchange area in a bath in which cold water is allowed to continuously flow.

According to need, pressure reducing units 6 and 8 can be installed in the upstream and downstream of the cooling unit 7. The pressure reducing units 6 and 8 have a structure in which one or more cells or two-way valves having a flow path that is larger than the diameter of the nozzle of the pulverizing unit 5 and smaller than the diameter of the pipe connected thereto are arranged.

A treatment using this high-pressure wet-type pulverizer is performed as follows.

First, priming water is filled up in the high-pressure wet-type pulverizer. The priming water refers to an aqueous solution to be filled up in the pipes of the high-pressure wet-type pulverizer before allowing the process liquid to flow therein.

Subsequently, the process liquid is fed to the hopper and subjected to a pulverization treatment.

First, the process liquid is heated to a temperature not lower than the glass transition temperature (Tg) of the binder resin. The reason why the liquid is heated is to melt the binder resin.

This heating temperature varies depending on the melting property of the binder resin. When the resin is easy to melt, the heating temperature may be set to a low temperature, however, when the resin is difficult to melt, the heating temperature should be set to a high temperature. Further, when a method of heating the liquid by continuously passing it through a heat exchanger is employed, the heating temperature is affected also by the flow rate of the dispersion liquid and the length of the pipe of the heat exchanger. When the flow rate is high or the length of the pipe is small, the heating temperature should be set to a high temperature, meanwhile, when the flow rate is low or the length of the pipe is large, the dispersion liquid is sufficiently heated, therefore, it is possible to perform the treatment at a low temperature. For example, when the flow rate is from 300 to 400 cc/min, the heat exchange pipe is a high-pressure pipe having a diameter of ⅜ inches and a length of 12 m, the Tg of the binder resin is 60° C., and the softening point (Tm) of the toner is 130° C., the heating temperature may be set to 100° C. to 200° C. The heating temperature can be in a range from the glass transition temperature (Tg) to Tg+150° C. When the heating temperature is too high, the binder resin tends to be hydrolyzed. If the heating temperature is from about Tg to Tg+150° C., a problem such as deterioration of fixability is not caused.

The softening point of the toner is measured by a temperature raising method using Flow Tester CFT-500 manufactured by Shimadzu Corporation, and the point on a curve which corresponds to a descent amount of the plunger of 2 mm on the chart is taken as the softening point.

Then, the dispersion liquid thus heated is subjected to a shearing force while applying a pressure of 10 MPa or more. At this time, it is the nozzle that applies the shearing force. By allowing the dispersion liquid to pass through the nozzle while applying a high pressure of 10 MPa or more, the molten toner components are pulverized into fine particles. The pressure at this time can be from 10 MPa to 300 MPa.

Finally, the dispersion liquid is cooled to a temperature not higher than the Tg of the binder resin. By this cooling, the molten fine particles are solidified. Since the process liquid is rapidly cooled, aggregation or coalescence due to cooling is difficult to occur.

According to need, a back-pressure may be applied to the upstream or downstream of the cooling unit or a pressure may be reduced there. The back-pressure application or pressure reduction is performed for returning the pressure of the process liquid after passing through the nozzle to close to atmospheric pressure in a single step (by back-pressure application) or in multiple steps (by pressure reduction) so as not to release the process liquid to atmospheric pressure immediately after passing through the nozzle. The pressure after passing through a back-pressure applying unit or a pressure reducing unit is from 0.1 MPa to 10 MPa, further from 0.1 MPa to 5 MPa. In this pressure reducing unit, a plurality of cells or valves with different diameters can be arranged. By reducing the pressure in multiple steps, coarse particles are few in number and fine particles having a sharp particle size distribution can be obtained.

When this high-pressure wet-type pulverizer is washed, an alkaline washing liquid can be used because dirt in the pipe is easy to wash away, and contamination of the subsequent process liquid can be suppressed to the minimum:

In this manner, it becomes possible to obtain fine particles having a size of 2 μm or less.

In the embodiment, in order to prepare a toner material in the form of particles containing a binder resin and a coloring agent, a mixture containing at least a binder resin and a coloring agent can be kneaded.

A kneader to be used is not particularly limited as long as it can perform melt-kneading, however, examples thereof include a single-screw extruder, a twin-screw extruder, a pressure kneader, a Banbury mixer, and a Brabender mixer. Specific examples thereof include FCM (manufactured by Kobe Steel, Ltd.), NCM (manufactured by Kobe Steel, Ltd.), LCM (manufactured by Kobe Steel, Ltd.), ACM (manufactured by Kobe Steel, Ltd.), KTX (manufactured by Kobe Steel, Ltd.), GT (manufactured by Ikegai, Ltd.), PCM (manufactured by Ikegai, Ltd.), TEX (manufactured by the Japan Steel Works, Ltd.), TEM (manufactured by Toshiba Machine Co., Ltd.), ZSK (manufactured by Warner K.K.), and Kneadex (manufactured by Mitsui Mining Co., Ltd.).

A dry-type crusher is not particularly limited as long as it can perform crushing in a dry process, and examples thereof include a ball mill, an atomizer, a bantam mill, a pulverizer, a hammer mill, a roll crusher, a cutter mill, and a jet mill.

A disperser, a mixer, and a wet-type crusher are not particularly limited as long as they can perform dispersion, mixing, and crushing, and examples thereof include rotor-stator stirrers and medium stirrers. Examples of the rotor-stator stirrer include Ultra Turrax (manufactured by IKA Japan K.K.), T.K. Auto Homo Mixer (manufactured by PRIMIX Corporation), T.K. Pipeline Homo Mixer (manufactured by PRIMIX Corporation), T.K. Filmics (manufactured by PRIMIX Corporation), Clear Mix (manufactured by M TECHNIQUE Co., Ltd.), Clear SS5 (manufactured by M TECHNIQUE Co., Ltd.), Cavitron (manufactured by EUROTEC, Ltd.), and Fine Flow Mill (manufactured by Pacific Machinery & Engineering Co., Ltd.). Examples of the medium stirrer include Visco Mill (manufactured by Aimex Co., Ltd.), Apex Mill (manufactured by Kotobuki Industries Co., Ltd.), Star Mill (manufactured by Ashizawa Finetech Co., Ltd.), DCP Superflow (manufactured by Nippon Eirich Co., Ltd.), MP Mill (manufactured by Inoue Manufacturing Co., Ltd.), Spike Mill (manufactured by Inoue Manufacturing Co., Ltd.), Mighty Mill (manufactured by Inoue Manufacturing Co., Ltd.), and SC Mill (manufactured by Mitsui Mining Co., Ltd.).

As a washing device, for example, a centrifugal separator, a filter press, or the like can be used. As the washing liquid, for example, water, ion exchanged water, purified water, water adjusted to acidic pH, water adjusted to basic pH, or the like is used.

As a drying device, for example, a vacuum dryer, an air-flow dryer, a fluidized dryer or the like can be used.

Examples of a dry-type mixer include Henschel Mixer (manufactured by Mitsui Mining Co., Ltd.), Super Mixer (manufactured by Kawata Mfg. Co., Ltd.), Ribocone (manufactured by Okawara Mfg. Co., Ltd.), Nauta Mixer (manufactured by Hosokawa Micron, Co., Ltd.), Turbulizer (manufactured by Hosokawa Micron, Co., Ltd.), Cyclo Mixer (manufactured by Hosokawa Micron, Co., Ltd.), Spiral Pin Mixer (manufactured by Pacific Machinery & Engineering Co., Ltd.), and Lodige Mixer (manufactured by Matsubo Corporation).

In the embodiment, in order to adjust the fluidity or chargeability of the toner particles, inorganic fine particles may be added and mixed in the surfaces of the toner particles in an amount of from 0.01 to 20% by weight based on the total weight of the toner. As such inorganic fine particles, silica, titania, alumina, strontium titanate, tin oxide, cerium oxide, and the like can be used alone or in admixture of two or more kinds thereof.

As the inorganic fine particles, inorganic fine particles surface-treated with a hydrophobizing agent can be used from the viewpoint of improvement of environmental stability. Further, other than such inorganic oxides, resin fine particles having a size of 1 μm or less may be externally added for improving the cleaning performance.

Examples of a mixer for inorganic fine particles or the like include Henschel Mixer (manufactured by Mitsui Mining Co., Ltd.), Super Mixer (manufactured by Kawata Mfg. Co., Ltd.), Ribocone (manufactured by Okawara Mfg. Co., Ltd.), Nauta Mixer (manufactured by Hosokawa Micron, Co., Ltd.), Turbulizer (manufactured by Hosokawa Micron, Co., Ltd.), Cyclo Mixer (manufactured by Hosokawa Micron, Co., Ltd.), Spiral Pin Mixer (manufactured by Pacific Machinery & Engineering Co., Ltd.), and Lodige Mixer (manufactured by Matsubo Corporation).

In the embodiment, further, coarse particles and the like may be sieved off. Examples of a sieving device which is used for sieving include Ultra Sonic (manufactured by Koei Sangyo Co., Ltd.), Gyro Shifter (manufactured by Tokuju Corporation), Vibrasonic System (manufactured by Dalton Co., Ltd.), Soniclean (manufactured by Shinto Kogyo K.K.), Turbo Screener (manufactured by Turbo Kogyo Co., Ltd.), Micro Shifter (manufactured by Makino Mfg. Co., Ltd.), and a circular vibrating sieve.

### EXAMPLES

Hereinafter, Examples will be described in detail, however, the scope of the embodiments is not limited to the Examples.

The physical properties of the toner were determined by the following methods.

### Measurement Method for Pulverized Particles

The particle diameter of pulverized particles was measured using SALD-7000 (manufactured by Shimadzu Corporation).

### Measurement Method for Toner Particles

The particle diameter of toner particles was measured using Multisizer 3 (manufactured by Beckman Coulter, Inc., aperture diameter: 100 μm).

### Measurement Method of Circularity of Toner

The circularity of a toner was measured using FPIA-2100 (manufactured by Sysmex Corporation).

### Charging Property

A charge amount under high temperature and high humidity conditions (HH) and a charge amount under low temperature and low humidity conditions (LL) were measured using a powder charge amount measuring device (Model TB-203, manufactured by Kyocera Chemical Corporation). As a charge retention, [(HH)/(LL)×100] was determined. When the charge retention is 60% or more, the charging property is favorable.

### Image Quality

A copier e-STUDIO 4520C manufactured by Toshiba Tec Corporation was modified for evaluation. After an image was output, the reflectance of white background was measured using X-Rite 938, and a difference between a mean value of the reflectance of white background and a mean value of the reflectance of untransferred paper was determined. When the difference between the mean values ΔE was 0.6 or less, the image quality was evaluated to be good.

### Preparation of Fine Particle Dispersion Liquid A

90 Parts by weight of a polyester resin as a binder resin, 5 parts by weight of a copper phthalocyanine pigment as a coloring agent, and 5 parts by weight of an ester wax as a release agent were mixed, and the resulting mixture was melt-kneaded using a twin-screw kneader which was set to a temperature of 120° C., whereby a kneaded material was obtained.

The thus obtained kneaded material was coarsely crushed to a volume average particle diameter of 1.2 mm using a hammer mill manufactured by Nara Machinery Co., Ltd., whereby coarse particles were obtained.

Subsequently, the thus obtained coarse particles were moderately crushed to a volume average particle diameter of 0.05 mm using a Bantam mill manufactured by Hosokawa Micron Corporation, whereby moderately crushed particles were obtained.

40 Parts by weight of the thus obtained moderately crushed particles, 0.4 parts by weight of sodium dodecylbenzene sulfonate as an anionic surfactant, 1 part by weight of triethylamine as an amine compound, and 58.6 parts by weight of ion exchanged water were processed at 160 MPa and 180° C. using NANO 3000, whereby a dispersion liquid (A) having a volume average particle diameter of 400 nm was prepared.

### Preparation of Fine Particle Dispersion Liquid B

90 Parts by weight of a polyester resin as a binder resin, 5 parts by weight of a copper phthalocyanine pigment as a coloring agent, and 5 parts by weight of an ester wax as a release agent were mixed, and the resulting mixture was melt-kneaded using a twin-screw kneader which was set to a temperature of 120° C., whereby a kneaded material was obtained.

The thus obtained kneaded material was coarsely crushed to a volume average particle diameter of 1.2 mm using a hammer mill manufactured by Nara Machinery Co., Ltd., whereby coarse particles were obtained.

Subsequently, the thus obtained coarse particles were moderately crushed to a volume average particle diameter of 0.05 mm using a Bantam mill manufactured by Hosokawa Micron Corporation, whereby moderately crushed particles were obtained.

Parts by weight of the thus obtained moderately crushed particles, 4 parts by weight of sodium dodecylbenzene sulfonate as an anionic surfactant, 1 part by weight of triethylamine as an amine compound, and 55 parts by weight of ion exchanged water were processed at 160 MPa and 180° C. using NANO 3000, whereby a dispersion liquid (B) having a volume average particle diameter of 300 nm was prepared.

### Example 1

To 25 parts by weight of the above dispersion liquid (A), 70 parts by weight of ion exchanged water was added and mixed. Then, as an aggregating agent, 5 parts by weight of 0.5% by weight hydrochloric acid was added thereto at 30° C., and the temperature of the resulting mixture was raised to 90° C. and the mixture was left as such for 2 hours.

After cooling, the solid in the thus obtained dispersion liquid was washed with 100 times volume of washing water. Thereafter, the washed solid was dried using a vacuum dryer until the water content became 0.3% by weight, whereby toner particles were obtained.

The electrical conductivity of the toner particles after drying was evaluated by the toner electrical conductivity evaluation method and found to be 15 μS/cm.

After drying, as additives, 2 parts by weight of hydrophobic silica and 0.5 parts by weight of titanium oxide were adhered to surfaces of the toner particles, whereby a desired electrophotographic toner was obtained.

The volume average particle diameter (using Multisizer 3 manufactured by Beckman Coulter, Inc.) and the circularity of the thus obtained electrophotographic toner were measured and found to be 5.32 μm and 0.954, respectively.

An EDX analysis was performed, and a ratio of a sodium element to a carbon element was found to be 0.2%.

As for the charging property, the charge amount under low temperature and low humidity conditions was 49.8 (−q/m), the charge amount under high temperature and high humidity conditions was 38.1 (−q/m), and the charge retention was 76.5%.

The image quality was good.

The obtained results are shown in the following Table 1.

### Example 2

To 25 parts by weight of the above dispersion liquid (B), 70 parts by weight of ion exchanged water was added and mixed. Then, as a metal salt, 5 parts by weight of a 5% by weight aqueous solution of aluminum sulfate was added thereto at 30° C., and after adding the metal salt, the temperature of the resulting mixture was raised to 50° C. In order to maintain the volume average particle diameter, 10 parts by weight of 10% by weight sodium dodecylbenzene sulfonate was added thereto as a stabilizing agent. In order to control the shape, the temperature of the mixture was raised to 95° C. and the mixture was left as such for 2 hours.

After cooling, the solid in the thus obtained dispersion liquid was washed with 300 times volume of washing water. Thereafter, the washed solid was dried using a vacuum dryer until the water content became 0.5% by weight, whereby toner particles were obtained.

The electrical conductivity of the toner particles after drying was evaluated by the toner electrical conductivity evaluation method and found to be 36 μS/cm.

After drying, as additives, 2 parts by weight of hydrophobic silica and 0.5 parts by weight of titanium oxide were adhered to surfaces of the toner particles, whereby a desired electrophotographic toner was obtained.

The volume average particle diameter (using Multisizer 3 manufactured by Beckman Coulter, Inc.) and the circularity of the thus obtained electrophotographic toner were measured and found to be 5.47 μm and 0.962, respectively.

An EDX analysis was performed, and a ratio of a sodium element to a carbon element was found to be 4.6%.

As for the charging property, the charge amount under low temperature and low humidity conditions was 45.8 (−q/m), the charge amount under high temperature and high humidity conditions was 27.6 (−q/m), and the charge retention was 60.3%.

The image quality was good.

The obtained results are shown in the following Table 1.

### Example 3

To 25 parts by weight of the above dispersion liquid (A), 70 parts by weight of ion exchanged water was added and mixed. Then, as an aggregating agent, 5 parts by weight of 0.5% by weight hydrochloric acid was added thereto at 30° C., and the temperature of the resulting mixture was raised to 90° C. and the mixture was left as such for 2 hours.

After cooling, the solid in the thus obtained dispersion liquid was washed with 10 times volume of washing water. Thereafter, the washed solid was dried using a vacuum dryer until the water content became 0.3% by weight, whereby toner particles were obtained.

The electrical conductivity of the toner particles after drying was evaluated by the toner electrical conductivity evaluation method and found to be 80 μS/cm.

Washing of the solid was repeated until the total amount of the washing water used reached 100 times volume of the solid. Thereafter, the washed solid was dried using a vacuum dryer until the water content became 0.3% by weight, whereby toner particles were obtained.

The electrical conductivity of the toner particles after drying was evaluated by the toner electrical conductivity evaluation method and found to be 20 μS/cm.

After drying, as additives, 2 parts by weight of hydrophobic silica and 0.5 parts by weight of titanium oxide were adhered to surfaces of the toner particles, whereby a desired electrophotographic toner was obtained.

The volume average particle diameter (using Multisizer 3 manufactured by Beckman Coulter, Inc.) and the circularity of the thus obtained electrophotographic toner were measured and found to be 5.32 μm and 0.954, respectively.

An EDX analysis was performed, and a ratio of a sodium element to a carbon element was found to be 0.28%.

As for the charging property, the charge amount under low temperature and low humidity conditions was 47.8 (−q/m), the charge amount under high temperature and high humidity conditions was 35.2 (−q/m), and the charge retention was 73.6%.

The image quality was good.

The obtained results are shown in the following Table 1.

### Example 4

To 25 parts by weight of the above dispersion liquid (A), 70 parts by weight of ion exchanged water was added and mixed. Then, as an aggregating agent, 5 parts by weight of 0.5% by weight hydrochloric acid was added thereto at 30° C., and the temperature of the resulting mixture was raised to 90° C. and the mixture was left as such for 2 hours.

After cooling, the solid in the thus obtained dispersion liquid was washed with 50 times volume of washing water. Thereafter, the washed solid was dried using a vacuum dryer until the water content became 0.3% by weight, whereby toner particles were obtained.

The electrical conductivity of the toner particles after drying was evaluated by the toner electrical conductivity evaluation method and found to be 42 μS/cm.

After drying, as additives, 2 parts by weight of hydrophobic silica and 0.5 parts by weight of titanium oxide were adhered to surfaces of the toner particles, whereby a desired electrophotographic toner was obtained.

The volume average particle diameter (using Multisizer 3 manufactured by Beckman Coulter, Inc.) and the circularity of the thus obtained electrophotographic toner were measured and found to be 5.32 μm and 0.954, respectively.

An EDX analysis was performed, and a ratio of a sodium element to a carbon element was found to be 4.53%.

As for the charging property, the charge amount under low temperature and low humidity conditions was 44.8 (−q/m), the charge amount under high temperature and high humidity conditions was 28.3 (−q/m), and the charge retention was 63.2%.

The image quality was good.

The obtained results are shown in the following Table 1.

### Comparative Example 1

To 25 parts by weight of the above dispersion liquid (B), 70 parts by weight of ion exchanged water was added and mixed. Then, as a metal salt, 5 parts by weight of a 5% by weight aqueous solution of aluminum sulfate was added thereto at 30° C., and after adding the metal salt, the temperature of the resulting mixture was raised to 50° C. In order to maintain the volume average particle diameter, 10 parts by weight of 10% by weight sodium dodecylbenzene sulfonate was added thereto as a stabilizing agent. In order to control the shape, the temperature of the mixture was raised to 95° C. and the mixture was left as such for 2 hours.

After cooling, the solid in the thus obtained dispersion liquid was washed with 100 times volume of washing water. Thereafter, the washed solid was dried using a vacuum dryer until the water content became 0.3% by weight, whereby toner particles were obtained.

The electrical conductivity of the toner particles after drying was evaluated by the toner electrical conductivity evaluation method and found to be 70 μS/cm.

After drying, as additives, 2 parts by weight of hydrophobic silica and 0.5 parts by weight of titanium oxide were adhered to surfaces of the toner particles, whereby a desired electrophotographic toner was obtained.

The volume average particle diameter (using Multisizer 3 manufactured by Beckman Coulter, Inc.) and the circularity of the thus obtained electrophotographic toner were measured and found to be 5.47 μm and 0.962, respectively.

An EDX analysis was performed, and a ratio of a sodium element to a carbon element was found to be 5.68%.

As for the charging property, the charge amount under low temperature and low humidity conditions was 38.5 (−q/m), the charge amount under high temperature and high humidity conditions was 18.5 (−q/m), and the charge retention was 48.1%.

The image quality was poor.

The obtained results are shown in the following Table 1.

### Comparative Example 2

To 25 parts by weight of the above dispersion liquid (A), 70 parts by weight of ion exchanged water was added and mixed. Then, as an aggregating agent, 5 parts by weight of 0.5% by weight hydrochloric acid was added thereto at 30° C., and the temperature of the resulting mixture was raised to 90° C. and the mixture was left as such for 2 hours.

After cooling, the solid in the thus obtained dispersion liquid was washed with 35 times volume of washing water. Thereafter, the washed solid was dried using a vacuum dryer until the water content became 0.3% by weight, whereby toner particles were obtained.

The electrical conductivity of the toner particles after drying was evaluated by the toner electrical conductivity evaluation method and found to be 48 μS/cm.

After drying, as additives, 2 parts by weight of hydrophobic silica and 0.5 parts by weight of titanium oxide were adhered to surfaces of the toner particles, whereby a desired electrophotographic toner was obtained.

The volume average particle diameter (using Multisizer 3 manufactured by Beckman Coulter, Inc.) and the circularity of the thus obtained electrophotographic toner were measured and found to be 5.32 μm and 0.954, respectively.

An EDX analysis was performed, and a ratio of a sodium element to a carbon element was found to be 5.19%.

As for the charging property, the charge amount under low temperature and low humidity conditions was 42.1 (−q/m), the charge amount under high temperature and high humidity conditions was 23.8 (−q/m), and the charge retention was 56.5%.

The image quality was moderate.

The obtained results are shown in the following Table 1.

### Comparative Example 3

To 25 parts by weight of the above dispersion liquid (B), 70 parts by weight of ion exchanged water was added and mixed. Then, as a metal salt, 5 parts by weight of a 5% by weight aqueous solution of aluminum sulfate was added thereto at 30° C., and after adding the metal salt, the temperature of the resulting mixture was raised to 50° C. In order to maintain the volume average particle diameter, 10 parts by weight of 10% by weight sodium dodecylbenzene sulfonate was added thereto as a stabilizing agent. In order to control the shape, the temperature of the mixture was raised to 95° C. and the mixture was left as such for 2 hours.

After cooling, the solid in the thus obtained dispersion liquid was washed with 180 times volume of washing water. Thereafter, the washed solid was dried using a vacuum dryer until the water content became 0.3% by weight, whereby toner particles were obtained.

The electrical conductivity of the toner particles after drying was evaluated by the toner electrical conductivity evaluation method and found to be 56 μS/cm.

After drying, as additives, 2 parts by weight of hydrophobic silica and 0.5 parts by weight of titanium oxide were adhered to surfaces of the toner particles, whereby a desired electrophotographic toner was obtained.

The volume average particle diameter (using Multisizer 3 manufactured by Beckman Coulter, Inc.) and the circularity of the thus obtained electrophotographic toner were measured and found to be 5.47 μm and 0.962, respectively.

An EDX analysis was performed, and a ratio of a sodium element to a carbon element was found to be 5.26%.

As for the charging property, the charge amount under low temperature and low humidity conditions was 40.6 (−q/m), the charge amount under high temperature and high humidity conditions was 23.1 (−q/m), and the charge retention was 56.9%.

The image quality was moderate.

The obtained results are shown in the following Table 1.

TABLE 1

| | Particle | Electrical | EDX | | Charge amount under | Charge amount under | | |
|---|---|---|---|---|---|---|---|---|
| | diameter | conductivity | analysis | | low temperature | high temperature | Charge | |
| | of toner | of washing | (Na/C) | Circu- | and low humidity | and high humidity | retention | Image |
| | (μm) | water (μS/cm) | (atom %) | larity | conditions (−q/m) | conditions (−q/m) | (%) | quality |
| Example 1 | 5.32 | 15 | 0.20 | 0.954 | 49.8 | 38.1 | 76.5 | Good |
| Example 2 | 5.47 | 35 | 4.20 | 0.962 | 45.8 | 27.6 | 60.3 | Good |
| Example 3 | 5.32 | 20 | 0.28 | 0.954 | 47.8 | 35.2 | 73.6 | Good |
| Example 4 | 5.32 | 42 | 4.53 | 0.954 | 44.8 | 28.3 | 63.2 | Good |
| Comparative | 5.47 | 70 | 5.68 | 0.962 | 38.5 | 18.5 | 48.1 | Poor |
| Example 1 | | | | | | | | |
| Comparative | 5.32 | 48 | 5.19 | 0.954 | 42.1 | 23.8 | 56.5 | Moderate |
| Example 2 | | | | | | | | |
| Comparative | 5.47 | 56 | 5.26 | 0.962 | 40.6 | 23.1 | 56.9 | Moderate |
| Example 3 | | | | | | | | |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for producing a developing agent comprising:
aggregating particles containing a binder resin and a coloring agent in a dispersion liquid in which the particles are dispersed in an aqueous medium to form aggregated particles;
washing and drying the aggregated particles to prepare toner particles, and adhering an additive to surfaces of the toner particles having an electrical conductivity measured by a toner electrical conductivity evaluation method of 50 μS/cm or less;
analyzing a composition of a region to which the additive is not adhered of the surfaces of the toner particles using an energy dispersive X-ray analyzer (EDX); and
producing a developing agent having a content ratio of a sodium element to carbon in the region to which the additive is not adhered of 5 atom % or less.

2. The method according to claim 1, wherein the toner electrical conductivity evaluation method is a method of evaluating an electrical conductivity of washing water in which after washing and drying a toner, water having an electrical conductivity of 0 μS/cm is added to the toner in an amount of 10 g per g of the toner, and the resulting liquid is treated with an ultrasonic washer for 10 minutes, and the treated liquid is filtered, and the electrical conductivity of the filtrate is 50 μS/cm or less.

3. The method according to claim 1, wherein when the electrical conductivity measured by the toner electrical conductivity evaluation method exceeds 50 μS/cm, the toner particles are rewashed until the electrical conductivity becomes 50 μS/cm or less, and thereafter, the additive is adhered to surfaces of the toner particles, and then, a composition of a region to which the additive is not adhered of the surfaces of the toner particles is analyzed using an energy dispersive X-ray analyzer (EDX).

4. The method according to claim 1, wherein the toner particles have a circularity of from 0.92 to 0.98.

5. The method according to claim 1, wherein the fine particles of a toner material are formed by melt-kneading a toner material containing a binder resin and a coloring agent, and crushing the kneaded material to form coarse particles of the toner material, and pulverize into fine particles.

6. The method according to claim 5, wherein the pulverization of coarse particles of the toner material into fine particles is performed by mechanical shearing.

7. The method according to claim 6, wherein the mechanical shearing is performed by a high-pressure homogenizer.

8. A developing agent obtained by aggregating particles containing a binder resin and a coloring agent in a dispersion liquid in which the particles are dispersed in an aqueous medium to form aggregated particles, and washing and drying the aggregated particles to prepare toner particles, and adhering an additive to surfaces of the toner particles having an electrical conductivity measured by a toner electrical conductivity evaluation method of 50 μS/cm or less; wherein
when a composition of a region to which the additive is not adhered of the surfaces of the toner particles is analyzed using an energy dispersive X-ray analyzer (EDX), a content ratio of a sodium element to carbon in the region to which the additive is not adhered is 5 atom % or less.

9. The developing agent according to claim 8, wherein the toner electrical conductivity evaluation method is a method of evaluating an electrical conductivity of washing water in which after washing and drying a toner, water having an electrical conductivity of 0 μS/cm is added to the toner in an amount of 10 g per g of the toner, and the resulting liquid is treated with an ultrasonic washer for 10 minutes, and the treated liquid is filtered, and the electrical conductivity of the filtrate is 50 μS/cm or less.

10. The developing agent according to claim 8, wherein when the electrical conductivity measured by the toner electrical conductivity evaluation method exceeds 50 μS/cm, the toner particles are rewashed until the electrical conductivity becomes 50 μS/cm or less, and thereafter, the additive is adhered to surfaces of the toner particles, and then, a composition of a region to which the additive is not adhered of the surfaces of the toner particles is analyzed using an energy dispersive X-ray analyzer (EDX).

11. The developing agent according to claim 8, wherein the toner particles have a circularity of from 0.92 to 0.98.

12. The developing agent according to claim 8, wherein the fine particles of a toner material are formed by melt-kneading a toner material containing a binder resin and a coloring agent, and crushing the kneaded material to form a particulate toner material, and pulverize into fine particles.

13. The developing agent according to claim 12, wherein the pulverization of the toner material in the form of particles is performed by mechanical shearing.

14. The developing agent according to claim 13, wherein the mechanical shearing is performed by a high-pressure homogenizer.
